(19) United States
(12) Patent Application Publication
(10) Pub. No.: US 2006/0191410 A1
(43) Pub. Date: Aug. 31, 2006

(54) NGL trap-method for recovery of heavy hydrocarbon from natural gas

(76) Inventors: William Bachon Dolan, Yardley, PA (US); Michael John Mitariten, Pittstown, NJ (US)

Correspondence Address: Attention: Chief Patent Counsel;ENGELHARD CORPORATION, 101 Wood Avenue, P.O. Box 770, Iselin, NJ, 08830-0770, US

(21) Appl. No.: 11/068,244

(22) Filed: Feb. 28, 2005

(51) Int. Cl. B01D 53/02

(52) U.S. Cl. 95/96

(57) ABSTRACT

A pressure swing adsorption process for the separation of nitrogen and/or CO₂ from natural gas utilizes two separate pressure swing adsorption stages, the first containing a hydrocarbon-selective adsorbent and the second containing a nitrogen- and/or CO₂-selective adsorbent. In the process, the product stream from the first pressure swing adsorption unit contains a natural gas stream having a reduced hydrocarbon content and the product stream from the second pressure swing adsorption unit is a natural gas stream having a reduced nitrogen and/or CO₂ concentration. An intermediate pressure stream containing methane from the second pressure swing adsorption unit is used to desorb the hydrocarbons from the first pressure swing adsorption unit. The C₃+ hydrocarbons can be separated as liquids from the methane.

### FIELD OF THE INVENTION

This invention relates to the purification of natural gas, and, more particularly, to the removal of nitrogen and/or carbon dioxide and recovery of C₃+ hydrocarbons from natural gas by use of a novel pressure swing adsorption (PSA) process.

### BACKGROUND OF THE INVENTION

The removal of nitrogen and acid gases such as carbon dioxide from natural gas is of considerable importance inasmuch as nitrogen and carbon dioxide can be present to a significant extent. Nitrogen and carbon dioxide contamination lower the heating value of the natural gas and increase the transportation cost based on unit heating value. It is also desirable or necessary to remove nitrogen and carbon dioxide from natural gas streams prior to liquefication of methane.

Applications aimed at removing nitrogen, carbon dioxide, and other impurities from natural gas steams streams provide significant benefits to the U.S. economy. In 1993, the Gas Research Institute (GRI) estimated that about one third of the natural gas reserves in the U.S. are defined as sub-quality due to contamination with nitrogen, carbon dioxide, and/or sulfur. Many of these reserves, however, have discounted market potential, if they are marketable at all, due to the inability to cost effectively remove the nitrogen and carbon dioxide. Nitrogen and carbon dioxide are inert gases with no BTU value and must be removed to low levels (4% total inerts typically and 2% carbon dioxide) before the gas can be sold.

Concurrently, the U.S. has proven reserves of natural gas totaling 167 trillion cubic feet. Over the past five years, annual consumption has exceeded the amount of new reserves that were found. This trend could result in higher cost natural gas and possible supply shortages in the future. As the U.S. reserves are produced and depleted, finding new, clean gas reserves involves more costly exploration efforts. This usually involves off shore exploration and/or deeper drilling onshore, both of which are expensive. Moreover, unlike crude oil, it is expensive to bring imports of natural gas into North America, therefore pricing of natural gas could be expected to rise forcing end users to seek alternative fuels, such as oil and coal, that are not as clean burning as gas. While base consumption for natural gas in the U.S. is projected to grow at 2-3% annually for the next ten years, one segment may grow much more rapidly. Natural gas usage in electric power generation is expected to grow rapidly because natural gas is efficient and cleaner burning allowing utilities to reduce emissions. Accordingly, there is a need to develop a cost-effective method of upgrading currently unmarketable sub-quality reserves in the U.S. thereby increasing the proven reserve inventory.

Methods heretofore known for purification of natural gas, in particular, nitrogen removal, may be divided roughly into three classifications:

(a) Methods involving fractional distillation at low temperature and (usually) high pressure, i.e. cryogenics. Since nitrogen has a lower boiling point than methane and the other hydrocarbons present in natural gas, it may be removed as a gas on liquefying the remaining constituents which are then revaporized.

(b) By selective adsorption of the methane and higher hydrocarbons on an adsorbent such as activated carbon. The adsorbed gases are then desorbed to give a gas reduced in the concentration of nitrogen.

(c) Miscellaneous processes involving selective diffusion through a series of organic membranes, formation of lithium nitride by treatment with lithium amalgam, absorption of the nitrogen in liquid ammonia or in liquid sulfur dioxide.

The principal disadvantage of the fractional distillation and adsorption processes is that they remove the major component, methane, from the minor component, nitrogen, instead of the reverse. In cryogenic processing, almost the entire volume of natural gas must be refrigerated, distilled, reheated, and usually compressed. Accordingly, cryogenic processing is expensive to install and operate, limiting its application to a small segment of reserves. Cryogenic technology is believed only capable of cost effectively purifying reserves, which exceed 50,000,000 standard cubic feet of gas per day. Gas reserves that do not fit these criteria are rarely being purified. The potential value of this gas is totally lost as the wells are usually capped. The processes suggested under paragraph (c) above are handicapped by an unsatisfactory degree of separation or by the use of very expensive materials.

In smaller-scale natural gas operations as well as in other areas such as synthesis gas and coke oven gas processing, adsorption processes can be especially well suited. The adsorption capacities of adsorption units can, in many cases, be readily adapted to process gas mixtures of varying nitrogen content without equipment modifications, i.e. by adjusting adsorption cycle times. Moreover, adsorption units can be conveniently skid-mounted, thus providing easy mobility between gas processing locations. Further, adsorption processes are often desirable because more than one component can be removed from the gas. As noted above, nitrogen-containing gases often contain other gases that contain molecules having smaller molecular dimensions than nitrogen, e.g., for natural gas, carbon dioxide, oxygen and water.

U.S. Pat. No. 2,843,219 discloses a process for removing nitrogen from natural gas utilizing zeolites broadly and contains specific examples for the use of zeolite 4A. The process disclosed in the patent suggests use of a first nitrogen selective adsorbent zeolite in combination with a second methane selective adsorbent. The molecular sieve adsorbent for removing nitrogen is primarily regenerated during desorption by thermal swing. A moving bed adsorption/desorption process is necessary for providing sufficient heat for the thermal swing desorption. The moving bed process specifically disclosed in this patent is not practical and it does not provide a cost efficient method for the separation of nitrogen from natural gas in view of high equipment and maintenance costs and degradation of the adsorbent by attrition due to contact with the moving adsorbent particles.

Despite the advantageous aspects of adsorption processes, the adsorptive separation of nitrogen from methane has been found to be particularly difficult. The primary problem is in finding an adsorbent that has sufficient selectivity for nitrogen over methane in order to provide a commercially viable process. In general, selectivity is related to polarizability, and methane is more polarizable than nitrogen. Therefore, the equilibrium adsorption selectivity of essentially all known adsorbents such as large pore zeolites, carbon, silica gel, alumina, etc. all favor methane adsorption over nitrogen. However, since nitrogen is a smaller molecule than methane, it is possible to have a small pore zeolite which adsorbs nitrogen faster than methane. Clinoptilolite is one of the zeolites which has been disclosed in literature as a rate selective adsorbent for the separation of nitrogen and methane.

U.S. Pat. No. 4,964,889 discloses the use of natural zeolites such as clinoptilolites having a magnesium cation content of at least 5 equivalent percent of the ion-exchangeable cations in the clinoptilolite molecular sieve for the removal of nitrogen from natural gas. The patent discloses that the separation can be performed by any known adsorption cycle such as pressure swing, thermal swing, displacement purge or nonadsorbable purge, although pressure swing adsorption is preferred. However, this patent is silent as to specifics of the process, such as steps for treating the waste gas, nor is there disclosure of a high overall system recovery.

It is well known to remove acid gases such as hydrogen sulfide and carbon dioxide from natural gas streams using an amine system wherein the acid gases are scrubbed from the feed with an aqueous amine solvent with the solvent subsequently stripped of the carbon dioxide or other acid gases and recirculated. These systems are widely used in industry with over 600 large units positioned in natural gas service in the U.S. The amine solvent suppliers compete vigorously and the amines used range from DEA to specialty formulations allowing smaller equipment and operating costs while incurring a higher solvent cost. These systems are well accepted although they are not very easy to operate. Keeping the amine solvents clean and equipment free of corrosion can be an issue.

Another disadvantage to using aqueous amines is that the natural gas product of an aqueous amine system is water saturated. Accordingly, dehydration typically using glycol absorption would be required on the product stream after the carbon dioxide has been removed adding operational and capital costs to the purification process.

For smaller volume applications where gas flows are less than five to ten million cubic feet per day, considerable attention has been given to the development of pressure swing adsorption (PSA) processes for removal of gaseous impurities such as CO₂.

Numerous patents describe PSA processes for separating carbon dioxide from methane or other gases. One of the earlier patents in this area is U.S. Pat. No. 3,751,878, which describes a PSA system using a zeolite molecular sieve that selectively adsorbs CO₂ from a low quality natural gas stream operating at a pressure of 1000 psia, and a temperature of 300° F. The system uses carbon dioxide as a purge to remove some adsorbed methane from the zeolite and to purge methane from the void space in the column. U.S. Pat. No. 4,077,779, describes the use of a carbon molecular sieve that adsorbs CO₂ selectively over hydrogen or methane. After the adsorption step, a high pressure purge with CO₂ is followed by pressure reduction and desorption of CO₂ followed by a rinse at an intermediate pressure with an extraneous gas such as air. The column is then subjected to vacuum to remove the extraneous gas and any remaining CO₂.

U.S. Pat. No. 4,770,676, describes a process combining a temperature swing adsorption (TSA) process with a PSA process for the recovery of methane from landfill gas. The TSA process removes water and minor impurities from the gas, which then goes to the PSA system, which is similar to that described in U.S. Pat. No. 4,077,779 above, except the external rinse step has been eliminated. CO₂ from the PSA section is heated and used to regenerate the TSA section. U.S. Pat. No. 4,857,083, claims an improvement over U.S. Pat. No. 4,077,779 by eliminating the external rinse step and using an internal rinse of secondary product gas (CO₂) during blowdown, and adding a vacuum for regeneration. The preferred type of adsorbent is activated carbon, but can be a zeolite such as 5A, molecular sieve carbons, silica gel, activated alumina or other adsorbents selective of carbon dioxide and gaseous hydrocarbons other than methane.

U.S. Pat. No. 4,915,711, describes a PSA process that uses adsorbents from essentially the same list as above, and produces two high purity products by flushing the product (methane) from the column with the secondary product (carbon dioxide) at low pressure, and regenerating the adsorbent using a vacuum of approximately 1 to 4 psia. The process includes an optional step of pressure equalization between columns during blowdown. U.S. Pat. No. 5,026,406 is a continuation-in-part of U.S. Pat. No. 4,915,711 with minor modifications of the process.

U.S. Pat. No. 5,938,819 discloses removing CO₂ from landfill gas, coal bed methane and coal mine gob gas, sewage gas or low quality natural gas in a modified PSA process using a clinoptilolite adsorbent. The adsorbent has such a strong attraction to CO₂ that little desorption occurs even at very low pressure. There is such an extreme hysteresis between the adsorption of the adsorbent and desorption isotherms, regeneration of the adsorbent is achieved by exposure to a stream of dry air.

In general, first applications of PSA processes were performed to achieve the objective of removing smaller quantities of adsorbable components from essentially non-adsorbable gases. Examples of such processes are the removal of water from air, also called heatless drying, or the removal of smaller quantities of impurities from hydrogen. Later this technology was extended to bulk separations such as the recovery of pure hydrogen from a stream containing 30 to 90 mole percent of hydrogen and other readily adsorbable components like carbon monoxide or dioxide, or, for example, the recovery of oxygen from air by selectively adsorbing nitrogen onto molecular sieves.

PSA processes are typically carried out in multi-bed systems as illustrated in U.S. Pat. No. 3,430,418 to Wagner, which describes a system having at least four beds. As is generally known and described in this patent, the PSA process is commonly performed in a cycle of a processing sequence that includes in each bed: (1) higher pressure adsorption with release of product effluent from the product end of the bed; (2) co-current depressurization to intermediate pressure with release of void space gas from the product end thereof; (3) countercurrent depressurization to a lower pressure; (4) purge; and (5) pressurization. The void space gas released during the co-current depressurization step is commonly employed for pressure equalization purposes and to provide purge gas to a bed at its lower desorption pressure.

Similar systems are known which utilize three beds for separations. See, for example, U.S. Pat. No. 3,738,087 to McCombs. The faster the beds perform steps 1 to 5 to complete a cycle, the smaller the beds can be when used to handle a given hourly feed gas flow. If two steps are performed simultaneously, the number of beds can be reduced or the speed of cycling increased; thus, reduced costs are obtainable.

U.S. Pat. No. 4,589,888 to Hiscock, et al. discloses that reduced cycle times are achieved by an advantageous combination of specific simultaneous processing steps. The gas released upon co-current depressurization from higher adsorption pressure is employed simultaneously for pressure equalization and purge purposes. Co-current depressurization is also performed at an intermediate pressure level, while countercurrent depressurization is simultaneously performed at the opposite end of the bed being depressurized.

The present assignee has developed an effective PSA process for the removal of nitrogen from natural gas streams. The process is described in U.S. Pat. No. 6,197,092, issued Mar. 6, 2001. In general, the process involves a first pressure swing adsorption of the natural gas stream to selectively remove nitrogen and produce a highly concentrated methane product stream. Secondly, the waste gas from the first PSA unit is passed through a PSA process which contains an adsorbent selective for methane so as to produce a highly concentrated nitrogen product. One important feature of the patented invention is the nitrogen selective adsorbent in the first PSA unit. This adsorbent is a crystalline titanium silicate molecular sieve also developed by the present assignee. The adsorbent is based on ETS-4 which is described in commonly assigned U.S. Pat. No. 4,938,939. ETS-4 is a novel molecular sieve formed of octrahedrally coordinated titania chains which are linked by tetrahedral silicon oxide units. The ETS-4 and related materials are, accordingly, quite different from the prior art aluminosilicate zeolites which are formed from tetrahedrally coordinated aluminum oxide and silicon oxide units. A nitrogen selective adsorbent useful in the process described in U.S. Pat. No. 6,197,092 is an ETS-4 which has been exchanged with heavier alkaline earth cations, in particular, barium. It has also been found by the present assignee that in appropriate cation forms, the pores of ETS-4 can be made to systematically shrink from slightly larger than 4 Å to less than 3 Å during calcinations, while maintaining substantial sample crystallinity. These pores may be frozen at any intermediate size by ceasing thermal treatment at the appropriate point and returning to ambient temperatures. These materials having controlled pore sizes are referred to as CTS-1 (contracted titano silicate-1) and are described in commonly assigned U.S. Pat. No. 6,068,682, issued May 30, 2000, incorporated herein by reference in its entirety. The CTS-1 molecular sieve is particularly effective in separating nitrogen and acid gases selectively from methane as the pores of the CTS-1 molecular sieve can be shrunk to a size to effectively adsorb the smaller nitrogen and carbon dioxide and exclude the larger methane molecule. The barium-exchanged ETS-4 for use in the separation of nitrogen from a mixture of the same with methane is described in commonly assigned U.S. Pat. No. 5,989,316, issued Nov. 23, 1999. Reference is also made to U.S. Pat. No. 6,315,817 issued Nov. 13, 2001, which also describes a pressure swing adsorption process for removal of nitrogen from a mixture of same with methane and the use of the Ba ETS-4 and CTS-1 molecular sieves. Due to the ability of the ETS-4 compositions, including the CTS-1 molecular sieves for separating gases based on molecular size, these molecular sieves have been referred to as Molecular Gate® sieves.

An apparent disadvantage of using Molecular Gate® titanium silicate sieves in processes for the removal of nitrogen from natural gas is that approximately one-half of the propane and all the butane and heavier hydrocarbon components are co-adsorbed with the nitrogen. Thus, it has been found that the C₃+ hydrocarbons, although too large to be adsorbed in the pores of the Molecular Gate® sieves, are adsorbed on the exterior surfaces of the sieves and binder used to hold the sieves together to form a particle. On regeneration of the sieves during the PSA process, the nitrogen and C₃+ components are combined as a low pressure tail gas. The C₃+ components represent a loss of desirable heating value and additional chemical value when present in the tail gas.

The majority of the market supply of C₂ and C₃+ hydrocarbons are extracted from natural gas. For this reason these components are commonly termed natural gas liquids (NGLs) or C₃ and C₄ as liquefied petroleum gas (LPG). The removal of the C₃+ hydrocarbons from natural gas is accomplished in three alternative routes.

In the first and oldest method, heavy oil is contacted with natural gas such that the lean oil wash absorbs C₃+ components into the liquid. These components are then stripped from the oil and eventually recovered as a separate product. More recent designs use refrigerated oil but overall this technology is considered outdated. A second method of recovery of C₃+ hydrocarbons is through a refrigeration system where the natural gas feed is chilled to temperatures typically in the range of −30° F. and the C₃+ components are substantially condensed from the natural gas stream. A more efficient, though more expensive, method and means to recover ethane as well, is generally applied to large gas flows where a turbo-expander plant expands the natural gas to a lower pressure. This expansion causes a substantial drop in the temperature of the natural gas stream. Once more, C₃+ hydrocarbons are removed. As a general rule turbo-expander plants are favored where ethane recovery is desired or higher levels of C₃+ liquids recovery is justified. These plants are expensive, especially for recompression. All of the routes for liquid recovery are fairly expensive in capital and require considerable power for either refrigeration or recompression.

The relationship in value of natural gas to natural gas liquids is complex and the prices, while related, do fluctuate. Almost always, the components are more valuable as a liquid than as a gas and a typical increase in value is about 1.5 times the value in the pipeline. The extraction of liquids is the main business of mid-stream processors.

The present assignee has- developed processes for the removal of nitrogen and recovery of hydrocarbons from natural gas utilizing pressure swing adsorption with Molecular Gate® sieves. These processes are described in U.S. Pat. No. 6,444,012, issued Sep. 3, 2002, and U.S. Pat. No. 6,497,750, issued Dec. 24, 2002. In the former U.S. Patent, the PSA process involves initially adsorbing C₃+ hydrocarbons from a natural gas stream in a first PSA unit containing a hydrocarbon-selective adsorbent to produce a first product stream comprising methane, nitrogen and reduced level of hydrocarbons relative to the feed. The first product stream is then directed to a second PSA adsorption unit containing a nitrogen selective adsorbent (Molecular Gate®) so as to adsorb nitrogen and produce a second product stream enriched with methane. Recovery of the hydrocarbons can be achieved by desorbing the first adsorbent with the methane product stream. In this way, the heat value of the C₃+ hydrocarbons is recaptured in the methane stream. This process is shown in FIG. 2, which will be further described below. The latter patent is directed to a process of separating nitrogen from a feed natural gas stream in a first PSA unit containing a Molecular Gate® nitrogen-selective adsorbent to form a methane product stream, directing the tail gas from the first PSA unit to a second PSA unit containing a methane selective adsorbent so as to recover methane from the tail gas to form a nitrogen rich product stream and a tail gas stream comprising hydrocarbons and cooling the hydrocarbon-containing tail gas so as to knock out the C₃+ hydrocarbon liquids. The methane is then recycled to feed.

In commonly assigned U.S. Pat. No. 6,610,124, nitrogen and carbon dioxide are removed from natural gas along with recovery of hydrocarbons. In the process, the natural gas stream is passed through a first adsorbent Molecular Gate® to form a product stream enriched with methane and to adsorb nitrogen and/or carbon dioxide and which further co-adsorbs at least a portion of the hydrocarbons contained in the feed stream. The hydrocarbons are recovered by passing a low pressure waste stream from the first pressure swing adsorption stage which contains co-adsorbed nitrogen and/or carbon dioxide and hydrocarbons and directing the waste stream to the second pressure swing adsorption stage to adsorb the hydrocarbons and produce a product stream enriched in nitrogen and/or carbon dioxide. The hydrocarbons are recovered from the hydrocarbon-selective adsorbent by an intermediate pressure methane-containing stream from the first pressure swing adsorption stage which purges the adsorbent in the second stage and forms a combined stream comprising methane and C₃+ hydrocarbons. The C₃+ hydrocarbons can be separated from the methane such as by compression with flash separation or refrigeration. This process is shown in FIG. 1, described below in more detail.

The process of the present invention which is described below, provides for both the effective removal of nitrogen and/or carbon dioxide from natural gas such as with a Molecular Gate® sieve and recovery of the C₃+ hydrocarbons which are also contained in the natural gas stream. The process of the present invention provides an alternative to previous processes for natural gas liquid recovery from natural gas streams as well as an alternative from the present assignee's own combined processes of nitrogen removal and hydrocarbon recovery from natural gas streams using pressure swing adsorption with Molecular Gate® sieves.

### SUMMARY OF THE INVENTION

This invention provides a novel PSA system to remove nitrogen and/or carbon dioxide from natural gas while also achieving high system hydrocarbon recovery. In accordance with this invention, a natural gas feed is first passed through an adsorbent selective for C₃+ hydrocarbon components operating in a PSA cycle and directing the product gas leaving the first PSA system to a second PSA system containing an adsorbent selective for nitrogen and/or carbon dioxide. A co-current intermediate pressure methane-containing vent stream of the second PSA is used to purge heavy hydrocarbons off the first PSA adsorbent for subsequent recovery.

### BRIEF DESCRIPTION OF THE DRAWINGS

FIG. 1 is a schematic of a prior art PSA process for selectively removing nitrogen and carbon dioxide from natural gas and the recovery of NGL components.

FIG. 2 is a schematic of a prior art PSA process which illustrates the initial removal of NGL components from natural gas and subsequent removal in a second PSA unit of nitrogen and carbon dioxide from the initial PSA product gas. Recovery of C₃₊ components is achieved by desorption of the C₃+ hydrocarbon by the second PSA product gas to yield a high heat value fuel stream reduced in N₂ or CO₂ concentration.

FIG. 3 is a schematic of the PSA process of the present invention similar to that shown in FIG. 2, except that C₃+ hydrocarbon recovery is achieved by desorption with an intermediate pressure vent stream.

### DETAILED DESCRIPTION OF THE INVENTION

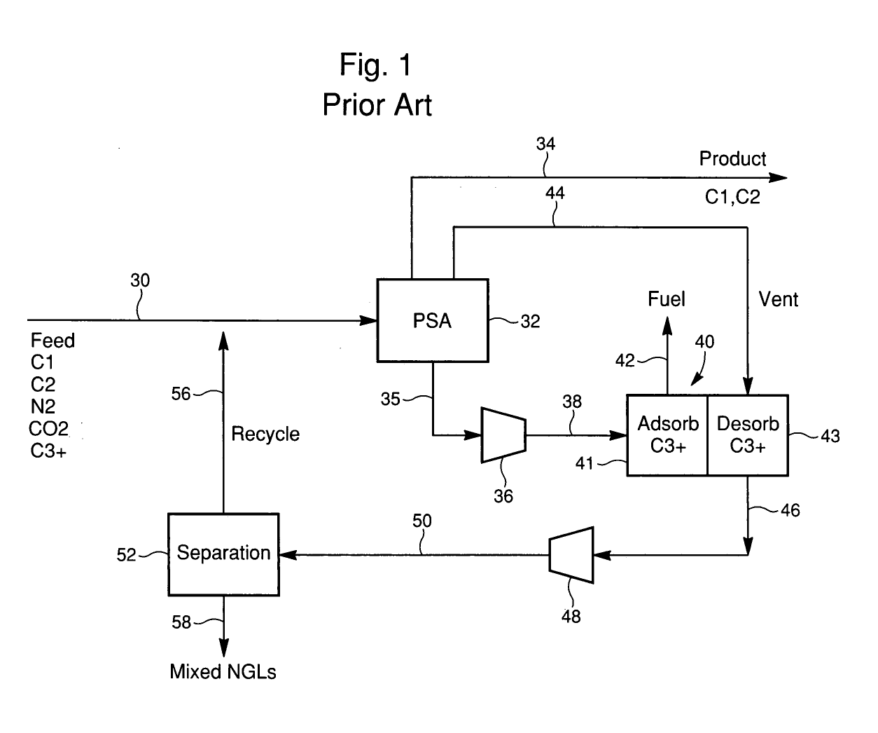

The present invention is directed to improvements in removing nitrogen and/or carbon dioxide from natural gas, and at the same time provide for the recovery of natural gas liquids in the form of C₃+ hydrocarbons. The present assignee has obtained patents on at least two processes capable of removing the nitrogen and carbon dioxide contaminants from natural gas, and at the same time recovering C₃₊ hydrocarbons as a liquid or a gas. FIG. 1 represents a prior art process described in U.S. Pat. No. 6,610,124. Referring to FIG. 1, feed stream 30 containing methane, nitrogen, carbon dioxide, and hydrocarbons such as ethane, propane, butane, and heavier hydrocarbons is directed to pressure swing adsorption unit 32, which contains one or more adsorbents selective for nitrogen and/or carbon dioxide. Particularly useful adsorbents are the titanium silicate molecular sieves, known as Molecular Gate® sieves, e.g., CTS-1, developed by the present assignee. PSA 32 effectively removes nitrogen and/or carbon dioxide from the natural gas stream to yield a product stream 34, which typically contains over 90 mol percent methane. It has been found that typically about 50% of the C₃+ hydrocarbons and substantially all of the C₄+ hydrocarbons are absorbed on the titanium silicate molecular sieves. The absorption of the heavier hydrocarbon is not due to size selectivity, as in the case in the adsorption of nitrogen and CO₂, which are adsorbed in the pores of the sieve, since the pores such as in CTS-1 are sized to accept nitrogen and CO₂, and not the larger methane or other hydrocarbon molecules. The C₃+ hydrocarbons are instead adsorbed on the exterior surface of the titanium silicate molecular sieve, believed due to electronic attractive forces between the heavy hydrocarbons and the sieve. Thus, upon conventional depressurization/desorption of PSA unit 32, a waste gas stream 35 containing desorbed nitrogen and carbon dioxide, and most of the C₃+ hydrocarbon content of the feed stream is formed. Low pressure waste stream 35 is pressurized via compressor 36 to a feed stream 38, which is directed to a second PSA unit 40. Adsorption in PSA unit 40 is depicted by reference numeral 41. PSA adsorption unit 41 contains a hydrocarbon selective adsorbent such as carbon which adsorbs the hydrocarbons in the waste gas, which have been purged from the void space of the adsorbent bed in PSA unit 32, and the C₃₊ hydrocarbons which were desorbed from the surface of the adsorbent bed in PSA unit 32. A stream 42 comprising a high concentration of nitrogen and/or CO₂, which is not adsorbed in PSA unit 40, can be recovered. If stream 42 contains non-adsorbed hydrocarbons, stream 42 can be used as a fuel stream.

Recovery of the natural gas liquids from the adsorbent bed in PSA unit 40 is achieved by forming a co-current, intermediate pressure vent stream 44 from PSA unit 32, which contains a high concentration of methane captured from the void space of the adsorbent bed in PSA unit 32. The vent stream at a pressure intermediate of the pressure of product stream 34 and waste stream 35 is contacted with the hydrocarbon-selective adsorbent in PSA unit 40. Desorption is depicted by reference numeral 43. Desorption unit 43 is contacted with vent stream 44 to desorb the hydrocarbons from the adsorbent to form stream 46. Stream 46 is pressured via compressor 48 to form mixed C₃₊ hydrocarbons stream 50, which also contains methane. Natural gas liquids can be separated from the lighter methane by any known method in the art. For example, flash separation or a refrigeration unit can be used for separation means 52. The natural gas liquids 58 can be condensed or otherwise separated from the methane component in any known matter. The methane can be recycled to the feed stream 30 via recycle line 56.

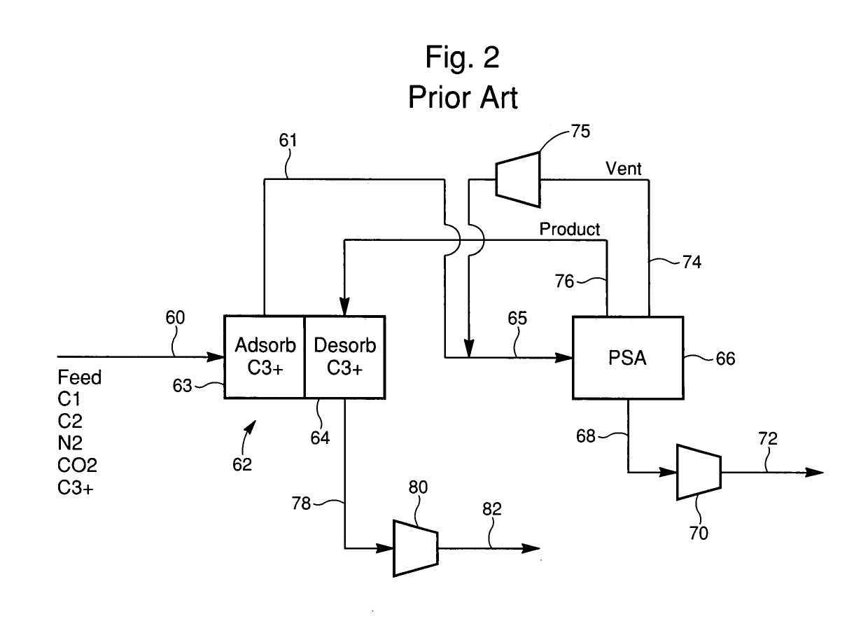

FIG. 2 also represents a prior art process scheme for removing nitrogen and/or CO₂ from a natural gas stream, and also recovering the C₃₊ hydrocarbons. This prior art process is described in commonly assigned in U.S. Pat. No. 6,444,012. As depicted in FIG. 2, feed stream 60, containing methane, ethane, C₃+ hydrocarbons, as well as nitrogen and/or carbon dioxide contaminants, is fed to PSA unit 62, which contains a bed of adsorbent which selectively adsorbs C₃+ hydrocarbons from the feed 60. Reference numeral 63 depicts adsorption in PSA 62. A product natural gas stream 61 leaves PSA unit 62 and is fed via line 65 to a second PSA unit 66 for removal of the nitrogen and/or carbon dioxide. Stream 65 is passed through a nitrogen and/or CO₂-selective adsorbent in PSA unit 66 to form a methane-rich product stream 76. The waste gas of PSA 66 is a nitrogen-rich and/or CO₂-rich stream 68. Stream 68 leaves PSA 66 during depressurization/desorption of the absorbent bed in PSA 66 to a low pressure, and is then compressed in compressor 70 to form waste gas stream 72. An intermediate pressure vent stream 74 is produced during co-current desorption of the adsorbent bed in PSA 66. Vent stream 74 is compressed by compressor 75 to feed pressure and recycled entirely back to feed 65 for PSA 66. The methane-rich product stream 76, subsequent to regeneration of PSA 66, is recycled to desorption 64 of PSA 62, and is used to purge the C₃+ hydrocarbons which have been adsorbed during the first stage PSA 62. The product gas rich in methane and now containing the C₃+ hydrocarbons desorbed from PSA 62 leaves the adsorbent bed via stream 78. Stream 78 is compressed to a high heat value sales gas as stream 82.

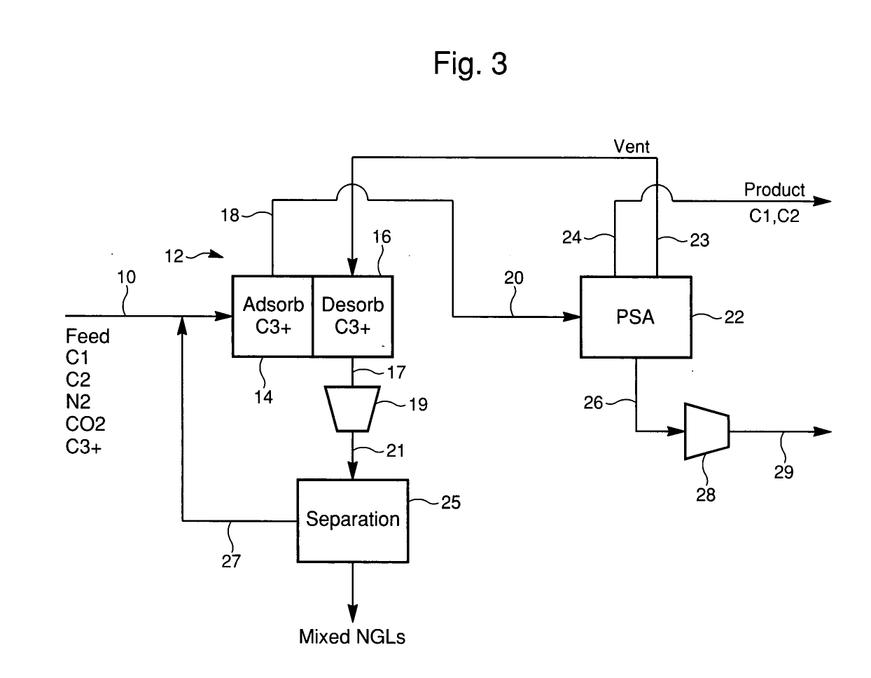

FIG. 3 represents the process of the present invention. The process depicted in FIG. 3 is very similar to that shown in FIG. 2. However, in accordance with the present invention, instead of utilizing the product methane stream from the second PSA unit to desorb the C₃+ hydrocarbons to yield a high value sales gas stream, the intermediate pressure vent stream from the second PSA unit is used to desorb the hydrocarbons, which stream is then compressed and treated for separation of the natural gas liquids from lighter hydrocarbon materials.

Thus, in general, the first stage of the process of the present invention involves the adsorptive removal of C₃+ hydrocarbons from the natural gas stream. The feed stream is passed through a hydrocarbon-selective adsorbent, which adsorbs the heavier hydrocarbons, especially propane, butane, and heavier hydrocarbons. Removal of butane is especially useful. A desirable feature of the invention comprises the regeneration of the hydrocarbon-selective adsorbent by purging the bed with an intermediate pressure gas stream formed in the second stage PSA. The advantage of the two-stage process is that the heavier hydrocarbons that would normally be adsorbed on the surface of the nitrogen-selective adsorbent and subsequently leave the PSA process as waste are now recovered as natural gas liquids.

An overview of the process of this invention can be described by referring to FIG. 3. As shown, a raw natural gas stream 10 enters the first stage PSA, represented by reference numeral 12. Feed stream 10 typically will contain 4-30 mol % nitrogen, 2-15 mol % carbon dioxide, and 5-20 mol % C₂ and hydrocarbons (2-15 mol % C₃+). The C₃+ hydrocarbons can be valuable chemical components if separated from the natural gas stream. The process steps of PSA 12 can be described by referring to adsorption 14 and desorption 16. In adsorption 14, natural gas feed stream 10 enters PSA 12, which contains a bed of adsorbent, which selectively adsorbs C₃+ hydrocarbons from natural gas stream 10. Preferably, an adsorbent is chosen to remove substantially all of the C₃ and higher hydrocarbons from the natural gas feed stream 10. Among useful hydrocarbon-selective adsorbents are carbon and crystalline aluminosilicate zeolites such as 13X, or a high aluminum X, or an amorphous adsorbent such as silica gel or activated alumina. A product natural gas stream 18 leaves PSA 12 and is reduced in pressure to a lower pressure feed stream 20.

Feed stream 20 is directed to a typical PSA unit 22 for the removal of impurities from the natural gas stream. In such process, feed stream 20 containing methane, nitrogen, and carbon dioxide, and now devoid of most hydrocarbons such as propane, butane, and heavier hydrocarbons at a feed pressure of about 80 to 800 psia is directed to a PSA unit 22 which contains a nitrogen and/or CO₂ selective adsorbent. Particularly useful nitrogen-selective adsorbents are the titanium silicate Molecular Gate® molecular sieves such as modified ETS-4 and related materials such as CTS-1 discovered by the present assignee. PSA unit 22 produces a product stream 24 which is a highly purified methane stream and which is not adsorbed on the adsorbent in PSA unit 22. Typically, the concentration of methane plus ethane in stream 24 is greater than 90 mol %, preferably greater than 95 mol % methane. Desorption of nitrogen and carbon dioxide which were initially adsorbed by the adsorbent in PSA 22 creates a low pressure waste gas stream 26, typically at a pressure less than 10 psia, containing nitrogen, polar gas such as carbon dioxide and water if present in the feed. The waste stream 26 is typically pressurized in vacuum compressor 28 to pressures of 15 to 45 psia as a tail gas 29.

The process of separating nitrogen and/or carbon dioxide from the natural gas stream 20 by pressure swing adsorption and the recovery of natural gas liquids adsorbed from the feed stream 10 can be described in more detail by referring again to FIG. 3. Again, referring to FIG. 3, feed stream 20 is directed to pressure swing adsorption unit 22 which contains one or more adsorbents selective for nitrogen and/or carbon dioxide such as those described previously. Particularly preferred adsorbents are the titanium silicate molecular sieves known as Molecular Gate® sieves developed by the present assignee. As disclosed in commonly assigned U.S. Pat. No. 6,068,682, it has been discovered that cationic forms of ETS-4 can be transformed into CTS-1, a titanium silicate of controlled pore size, by heating. Preferably, ETS-4 in the strontium or calcium form with or without low levels of sodium is heated at temperatures ranging from about 50° C. to 450° C., preferably 200° C. to 350° C. for 0.5 to 100 or more hours, preferably 24-48 hours, then cooled in order to lock in the desired pore size. Cooling can be accomplished in an air stream, which is free of CO₂ and water. Other inert gases may be used as long as such gases are free of CO₂ and water. The calcination temperature used to achieve a desired pore diameter depends on the cations present in the reagent ETS-4. Although multivalent strontium and calcium are the preferred cations for CTS-1, other cations can be used with appropriate changes of temperatures and durations of thermal treatment. Various combinations of Sr, Ca, Li, Mg, Na, H, Ba, Y, La, and/or Zn have all demonstrated separation selectivities. Additionally the CTS-1 materials can be back-exchanged with metal, ammonium, or hydrogen ions in a conventional manner if such is desired.

Also useful as a Molecular Gate® adsorbent is barium-exchanged ETS-4 without pore contraction via calcination. This material is explicitly disclosed in U.S. Pat. No. 5,989,316. The barium-exchanged ETS-4 is prepared by contacting ETS-4 with an inorganic salt of barium in order to affect the desired exchange. Still further, ETS-4 exchanged with a mixture of multivalent cations, with or without barium is also useful. Non-limiting examples of such multivalent cations include Sr, Ca, Mg, and Zn.

The ETS-4 which is used as the starting material can be prepared in accordance with the teachings of U.S. Pat. No. 4,938,939 wherein the haloid-containing reactants are used or can be prepared from reaction mixtures which are free from haloid-containing reactants in a manner analogous to the preparations of ETS-10 as set forth in U.S. Pat. No. 5,453,263, the entire disclosures of which are incorporated herein by reference.

Regarding the specific operation of PSA 22, the following steps are followed: adsorption, equalization, co-current depressurization to compression, provide purge, fuel, countercurrent depressurization, purge, equalization and pressurization. These steps are well-known to those of ordinary skill in this art. Reference is again made to U.S. Pat. Nos. 3,430,418; 3,738,087 and 4,589,888 for a discussion of these internal steps of a PSA process. The adsorption process in PSA unit 22 begins with the nitrogen and/or CO₂ adsorption step in which gas stream 20 at a pressure of about 80-800 psia, a temperature of 70-200° F., and typically containing 4-30 mol. % nitrogen and 2-15 mol % carbon dioxide, is fed to a bed containing a nitrogen and/or CO₂-selective adsorbent as discussed above. At nitrogen levels less than 4.0 mol. % and CO₂ levels of less than 2.0 mol. %, generally pipeline specifications are met and there is no need to separate these impurities, unless total impurity (N₂+CO₂) levels are greater than 4.0 mol. %. Nitrogen and/or CO₂ adsorption yields a product stream 24 rich in methane, reduced in nitrogen and CO₂ and at approximately the same operational pressure as feed 20. After the adsorption step, the bed is co-currently depressurized in a series of steps referred to in the art as equalizations or to provide purge gas to a vessel undergoing regeneration. After the adsorbent bed has completed 1 to 4 equalizations, the adsorbent bed can be further co-currently depressurized. The gas leaving the bed during the co-current depressurization, depicted as stream 25 can be used as either fuel, provide purge, recycled back to feed or any combination thereof. In this invention, co-current vent stream 23 is used to desorb C₃+ hydrocarbons from the adsorbent in PSA unit 12. Stream 23 will have a pressure of 10 to 100 psia, preferably 15 to 60 psia. Subsequently, the bed in PSA unit 22 is counter-currently depressurized, and then purged with gas from a provide purge step. The adsorbent bed is pressurized with gas from earlier equalizations, and finally the bed is pressurized with product gas or alternatively feed gas. These steps are routine, and except for directing the co-current intermediate pressure vent stream 23 to desorb PSA unit 12 are known in the art. This latter step is unique and important for C₃+ recovery and overall process efficiency including improvement in operational costs. By using a co-current vent stream for desorption instead of a portion of the waste stream, operational energy costs (compression costs) are saved as the vent stream 23 is compressed to sufficient pressure for NGL separation from a higher pressure than would be a waste stream portion. Subsequent to desorption with vent stream 23, a further depressurization/equalization step to about 15 psia can be performed to recover methane from void space gas before a final purge to waste gas at low pressure, e.g. 7 psia.

Recovery of the natural gas liquids from the adsorbent bed in PSA unit 12 is achieved by forming a co-current, intermediate pressure vent stream 23 from PSA unit 22 which contains a high concentration of methane captured from the void space of the adsorbent bed in PSA unit 22. The vent stream 23 at a pressure intermediate that of the pressure of product stream 24 and waste stream 26 is contacted with the hydrocarbon-selective adsorbent in PSA unit 12, indicated as desorption unit 16, so as to desorb the hydrocarbons from the adsorbent to form stream 17. Stream 17 is pressurized via compressor 19 to form mixed NGL stream 21, which also contains methane. The natural gas liquids can be separated from the lighter methane by any known method in the art. In FIG. 3, separation zone 25 can, for example, comprise a flash separator or a refrigeration unit to provide separation of methane from the NGLs. The natural gas liquids 27 can be condensed or otherwise separated from the methane component in any known manner. The methane can be recycled to feed stream 10 via recycle line 27.

Once given the above disclosure, many other features, modifications, and improvements will become apparent to the skilled artisan. Such other features, modifications, and improvements are, therefore, considered to be a part of this invention, the scope of which is to be determined by the following claims.

What is claimed is:

1. A process for the separation of nitrogen and/or carbon dioxide and hydrocarbons from a natural gas stream, which comprises:
passing said natural gas stream to a first pressure swing adsorption unit containing a hydrocarbon-selective sorbent so as to preferentially adsorb at least C₄+ hydrocarbons to produce a first product stream comprising methane, nitrogen, carbon dioxide, and a reduced level of said hydrocarbons relative to said natural gas stream;
passing said first product stream to a second pressure swing absorption unit containing a nitrogen-selective sorbent and/or a carbon dioxide-selective sorbent so as to preferentially adsorb nitrogen and/or carbon dioxide and produce a second product stream enriched with methane and a low pressure purge stream having a higher molar concentration of nitrogen and/or carbon dioxide than said first product stream;
co-currently depressurizing said second pressure swing adsorption unit to form an intermediate pressure vent stream having a pressure lower than said second product stream and higher than said purge stream, and
passing said vent stream in contact with said hydrocarbon-selective sorbent subsequent to formation of said first product stream so as to desorb said C₄+ hydrocarbons into said vent stream.

2. The process of claim 1, wherein said hydrocarbon-selective sorbent preferentially adsorbs C₃+ hydrocarbons, and said C₃+ hydrocarbons are desorbed into said vent stream.

3. The process of claim 1, wherein said hydrocarbon-selective sorbent is silica gel, activated alumina, carbon, zeolite 13X, high aluminum zeolite X.

4. The process of claim 1, wherein said nitrogen- and carbon dioxide-selective sorbent is CTS-1 titanium silicate having a pore size of about 3 to less than 4 Å.

5. The process of claim 3, wherein said nitrogen- and carbon dioxide-selective sorbent is CTS-1 titanium silicate having a pore size of about 3 to less than 4 Å.

6. The process of claim 1, wherein said nitrogen- and carbon dioxide-selective sorbent is barium exchanged ETS-4 titanium silicate wherein barium represents at least 30% of the exchangeable cations on said titanium silicate.

7. The process of claim 1, wherein said natural gas stream contains over 4 mole % nitrogen.

8. The process of claim 1, wherein said first product stream is essentially devoid of C₄+ hydrocarbons.

9. The process of claim 1, wherein said first product stream has reduced levels of propane relative to said natural gas stream.

10. The process of claim 7, wherein said natural gas stream contains over 2 mol % carbon dioxide.

11. The process of claim 10, wherein said second pressure swing adsorption unit contains sorbent selective to both nitrogen and carbon dioxide.

12. The process of claim 11, wherein said sorbent in said second pressure swing adsorption unit includes a mixture of nitrogen-selective sorbent and CO₂-selective sorbent.

13. The process of claim 11, wherein said natural gas stream contains 2-15 mol % CO₂.

14. The process of claim 1, wherein said natural gas stream contains 2-15 mol % C₃+ hydrocarbons.

15. The process of claim 2 wherein said vent stream contains methane.

16. The process of claim 15 wherein said C₃+ hydrocarbons are separated from said methane in said vent stream as liquids.

17. The process of claim 16 wherein said methane in said vent stream is recycled to said natural gas stream subsequent to separation of said C₃+ hydrocarbons.
